(19) United States
(12) Patent Application Publication
(10) Pub. No.: US 2016/0063453 A1
(43) Pub. Date: Mar. 3, 2016

(54) information system and method for processing information, in particular for assisting work in a motor vehicle repair shop

(71) Applicant: ROBERT BOSCH GMBH, Stuttgart (DE)

(72) Inventors: Clemens GUENTHER, Ettlingen (DE); Hans-Udo Lebherz, Wernau (DE); Christoph Noack, Schwieberdingen (DE); Hans Messener, Winterbach (DE)

(21) Appl. No.: 14/888,638

(22) PCT Filed: Mar. 11, 2014
(86) PCT No.: PCT/EP2014/054673

§ 371 Date: Nov. 2, 2015

(30) Foreign Application Priority Data
May 3, 2013 (DE) 10 2013 208 169.3

(51) Int. Cl. G06Q 10/00

(52) U.S. Cl. CPC G06Q 10/20

(57) ABSTRACT

An information system, in particular for a motor vehicle repair shop, includes at least one input unit to input data, in particular data about a motor vehicle to be repaired; a data management and/or data processing unit to store, managing and/or processing the inputted data; and at least one terminal to retrieve, reproduce and process the inputted data and/or for inputting additional data and transfer these data to the data management and/or data processing unit.

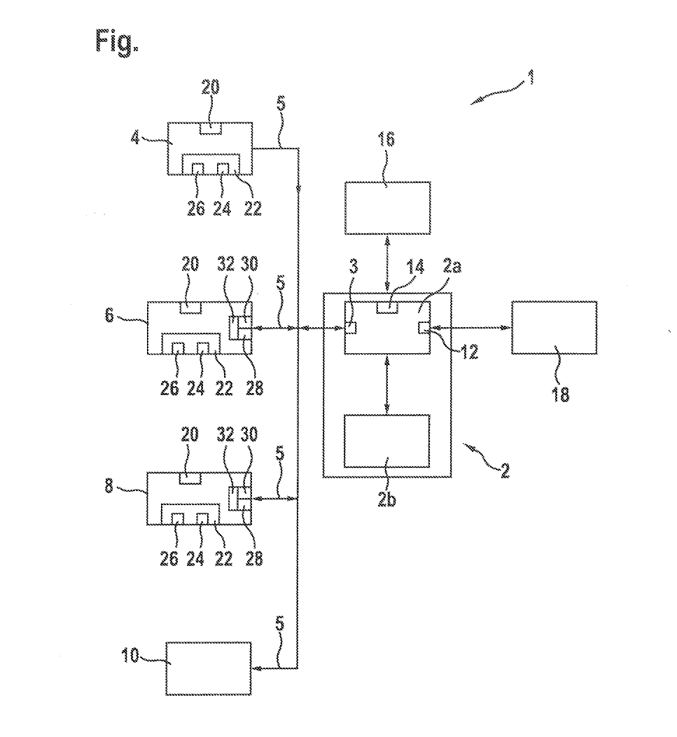

### FIELD OF THE INVENTION

The present invention relates to an information system, in particular for a motor vehicle repair shop.

### BACKGROUND INFORMATION

“Job slips” in the form of paper forms may be used in the shop work area of automotive repair shops to document the work order, to retrace the work flow and to document the materials used. Before starting work, the contents of these job slips are compiled and printed out in an electronic management system (dealer management system, DMS) and transferred to the repair shop work area. The information generated in doing the work in the repair shop work area is entered by hand into the job slip by the mechanics and transferred manually to the electronic management system for charging for the job after completion of the work. In the repair shops, this results in an integration gap between the electronic management system, which is used in the administration and bookkeeping, and the paper forms used in the repair shop area.

### SUMMARY OF THE INVENTION

One object of the present invention is to make available a method and an information system for improving the information flow between a repair shop area and the corresponding administrative area in particular.

An information system, which is suitable in particular for supporting the information flow in work in a (motor vehicle) repair shop includes at least one input unit which is configured for inputting data, in particular data about a motor vehicle to be repaired; a data management and/or data processing unit, which is configured for storing, managing and/or processing, i.e., evaluating the inputted data; and at least one terminal, which is configured for retrieving, reproducing and/or processing the inputted data from the data management and/or data processing unit and/or to input additional data and transfer the latter to the data management and/or data processing unit.

A method according to the present invention for information processing, in particular for improving the information flow when working in a (motor vehicle) repair shop includes the steps:
a) inputting data, in particular data concerning a motor vehicle to be repaired, via at least one input unit, and transferring the data to a data management and/or data processing unit;
b) retrieving, reproducing and/or processing data using at least one terminal from the data management and/or data processing unit and/or inputting additional data using the at least one terminal and transfer thereof to the data management and/or data processing unit.

Data from the data management and/or data processing unit in particular may be retrieved into a terminal by using an information system and method according to the present invention and displayed, supplemented and/or processed on the terminal. Subsequently, the supplemented and/or processed data may be stored again in the data management and/or data processing unit. In this way the data stored in the data management and/or data processing unit may be kept always up to date with the aid of the terminal.

The present invention prevents an integration gap in the information chain, in particular between the administration and repair shop areas since all information is detected directly electronically, stored and transferred. Both the mechanics in the repair shop and the employees in administration are able to access all available information immediately as needed and alter the data stored in the system and thereby optimize work flow both in administration and in the repair shop area. The loss and falsification of information due to transfer errors during the manual transfer between the electronic system and the paper slips used previously are reliably preventable. The work flow in the repair shop and in the office may be documented without a gap and carried out more reliably, i.e., with less susceptibility to error.

In one specific embodiment, the method additionally includes the steps:
c) carrying out measurements using the at least one terminal and modifying and/or supplementing the data retrieved into the terminal on the basis of the measuring results;
d) transferring the modified and/or supplemented data and/or the measuring results from the terminal to the data management and/or data processing unit.

The method may also include the steps:
e) evaluating and processing the modified and/or supplemented data in the data management and/or data processing unit and
f) outputting the result of the processing via a playback unit.

In one specific embodiment, the information system includes at least one output unit which is configured for outputting data from the information system.

In one specific embodiment, at least one terminal is configured for conducting measurements which are carried out in particular on a motor vehicle, which is to be repaired and to automatically transfer the measuring results to the data management and/or data processing unit with the aid of a transmission unit. The measuring results are thus available immediately for evaluation and documentation. The risk of the measuring results being falsified during a manual transfer is ruled out. Large quantities of measured data, the manual transfer of which would be very time consuming and subject to error, may be transferred reliably within a short period of time.

In one specific embodiment, the at least one terminal is configured for carrying out measurements, in particular on a motor vehicle to be repaired and it additionally has a receiving unit which is configured for receiving data from the data management and/or data processing unit, a processing unit which is configured for modifying and/or supplementing the data received by the receiving unit on the basis of the results of the measurements and a transmission unit which is configured for transferring the modified and/or supplemented data from the terminal to the data management and/or data processing unit.

In this way data stored in the data management and/or data processing unit may be modified and updated in particular in a simple and reliable manner on the basis of measurements carried out on the motor vehicle. These may be in particular data, such as the prevailing mileage reading, which have been read out and stored in the data management and/or data processing unit at a previous visit to the repair shop.

The receiving unit, the transmitting unit and the processing unit may be configured as hardware, software or as a combination thereof. These units may also be configured as separate units or as integrated transmission and receiving units or as an integrated transmission and/or receiving and processing unit.

In one specific embodiment, at least one terminal is configured as a mobile terminal, in particular as a tablet PC or smartphone. Mobile terminals are simple to handle and facilitate the recording of measured values. Tablet PC or smartphones are available at favorable prices in the consumer market.

In one specific embodiment, wireless data transfer between at least one terminal and the data management and/or data processing unit is possible (using Bluetooth®, WLAN or infrared technology, for example). The ease of handling of the terminal is further improved in this way since it is possible to omit a cable connection between the data management and/or data processing unit and the terminal which would restrict handling and mobility.

In one specific embodiment, the information system includes at least one electronic interface, which makes it possible to exchange data with an external system. The data may be transferred to an external system via the electronic interface for further processing, evaluation and/or diagnosis. In particular backup copies of the data may be prepared and/or the data processing may be continued at a different location or on a more powerful computer.

In one specific embodiment, the information system has an authentication device, which is configured for authenticating a user of the repair shop system and/or for authorizing the input and output of data. The operational reliability of the information system may be increased in this way since only authorized persons are allowed to enter data into the system and access data stored in the system. Misuse of the data may be reliably prevented in this way.

In one specific embodiment, an authentication device is provided in at least one terminal. An authentication device provided in a terminal makes it possible for a user to conveniently conduct an authentication and/or authorization on a terminal he is using to carry out the planned work steps, without accessing a separate authentication device.

In one specific embodiment, the information system has an identification device, which is configured for identifying an object, in particular a motor vehicle to be repaired. In this way master data belonging to the object may be transferred automatically as identification data to the data management and/or data processing unit. The work flow and in particular the data acquisition may be simplified and configured to be less susceptible to error.

In one specific embodiment, the identification device includes a camera and/or an RFID reader. A camera and/or an RFID reader permit(s) convenient and reliable identification of the object on the basis of its shape and/or color or on the basis of an RFID tag attached to the object.

One example of a repair shop throughput is described below using an exemplary embodiment of an information system according to the present invention:

### 1. Order Creation and Vehicle Identification:

During order creation, the vehicle is identified manually or automatically (see below), the vehicle data and the customer data being acquired and stored via at least one input unit as a data record, the so-called “electronic work card,” in the data management and/or data processing unit.

The “vehicle identification” (“vehicle ID”) may include automatic detection of the vehicle by a technical approach, such as, for example, detecting the license plate of the vehicle, noticeable vehicle feature or an RFID chip attached to the vehicle.

In the initial identification of a vehicle, information such as the make and the model of the vehicle is detected and transferred directly to the so-called electronic work card. This information is then available for electronic information exchange. The automatic transfer of information saves time for the repair shop employee and prevents errors which may occur due to manual data input and transfer.

If a vehicle which is already known is recognized again, for example, when a dialogue is initiated or the vehicle is selected for processing in the repair shop area, it is possible to access the work cards already assigned to this vehicle, so that the data stored previously for this vehicle and the measurements and work carried out on this vehicle may be accessed easily and quickly.

During order creation, manual changes to the data, desired by the user (e.g., additions, corrections), are basically possible. The system may restrict changes in this information, for example, by requiring a user to initially be authenticated with respect to the system before being able to make changes in the data.

### 2. Diagnosis:

For at least one following diagnostic step (“vehicle diagnosis”) in a modern vehicle, electronic diagnostic systems are required for a large portion of the work to be carried out.

In one example of a diagnostic step, a terminal which is configured as a vehicle diagnostic unit is connected to the electronic control unit of the vehicle for hard-wired or wireless data transfer. The vehicle diagnostic device reads vehicle-specific data, which may include in particular setpoint data or previous measured values of parameters of the control unit, out of the data management and/or data processing unit and then carries out the predefined diagnostic steps. The diagnostic steps may include in particular adjusting operating states of the engine or other components of the motor vehicle predefined by the control unit and conducting measurements in these operating states of the engine to ascertain measured values which will be used as the basis for further diagnosis.

The measured values ascertain in this way may be transferred directly to the data management and/or data processing unit in order to be evaluated there. Additionally or alternatively, the measured values ascertained are used to modify the data read out from the data management and/or data processing unit and/or to modify and to update the data. The modified and/or updated data may then be transferred to the data management and/or data processing unit where they are stored and/or evaluated.

Using the information system according to the present invention, an integration gap during data transfer is avoided due to the connection of the diagnostic system to the information system.

During the processing with electronic diagnostic applications, the overall system is able to ascertain the type of activity in many cases and to document this information and/or use it in the further repair process. For example, shortly after acceptance of the vehicle in the repair shop, a diagnosis of the control unit may be carried out to determine the actual condition of the vehicle and possibly existing defects. The results of the control unit diagnosis may be documented automatically by the system. This may aid to prevent or refute future complaints.

In the event of recurring defects it is helpful if the mechanic is able to access previous repair attempts, even if they failed, and their (detailed) results. If all repair processes and repair results are document in this way, then the information system contains an ideally complete documentation on the vehicle, resembling a patient file.

If the activities or attempted repairs carried out and documented previously restrict the list of possible defects, then proposals for additional diagnostic steps or attempted repairs may be submitted to the user in a targeted manner on the basis of the available documentation.

### 3. Repairs

Parallel or serial work on a vehicle by multiple mechanics or at multiple work stations is possible. Using an information system according to the present invention, the information exchange between the participating mechanics is greatly simplified and improved since all available information is available to all participants directly and almost immediately.

The vehicle/repair data may be stored for evaluation and evaluated, for example, for ascertaining the rate of damage to vehicles. The electronic work card is a necessary precondition for data collection for a subsequent data analysis (“data mining”). Storage and analysis may be carried out locally in the information system in the data management and/or data processing unit or centrally. The results of the evaluation may be made available, for example, to the repair shop itself, to the manufacturer or to a group of repair shops (“repair shop community”).

The collected history of the activities on the vehicle during the repair shop diagnosis is always available during work on the vehicle and even after conclusion of the work. This information may be made available completely or “partially actively,” for example, on the basis of the analysis of the work carried out. “Partially active” in this case means that there may be suggestions and instructions for the further course of repairs when it is known to the system which work has already been done on the basis of the available documentation. For example, if extensive maintenance is pending, in which the V-belt is to be replaced according to the checklist, for example, among other things, the system is able to check on whether the V-belt had already been replaced previously, for example, as part of another repair, so that renewed replacement of the V-belt is no longer necessary.

### 4. Spare Part Order:

Due to the simple availability of the technical information, a connection to other support systems is meaningful and readily possible. For example, the spare part order may be simplified and automated since the technical vehicle information is already available.

### 5. Documentation and Invoicing

The data collected in the data management and/or data processing unit during the diagnosis and repair may be used for automatic billing or may support manual invoice preparation. For written documentation of the work carried out, the electronic work card may also be printed out at any time in a form similar to today's work cards.

The present invention enables optimization of work flow due to the elimination of the integration gap/tool gap (for example, between an electronic system and paper) and, by avoiding double entries, for example, the vehicle ID, it also permits increased efficiency in the repair shop. This creates a transparent value added chain, which enables an optimal utilization of individual repair shop areas. Data belonging to a certain repair process may be ascertained automatically and without any gaps. This permits automatic documentation and feedback of the results.

The present invention is explained in greater detail below on the basis of the attached FIGURE.

### BRIEF DESCRIPTION OF THE DRAWING

The FIGURE shows an exemplary embodiment of an information system according to the present invention.

### DETAILED DESCRIPTION

Information system 1 has a central data management and/or data processing unit 2 which includes a data management unit 2a and a data processing and evaluation unit 2b.

Data management unit 2a is connected to at least one input unit 4, one or multiple terminals 6, 8 and at least one output unit 10 via a first interface 3 and data links 5, which may be configured to be hardwired, for example, as a bus, or wireless.

At least one input unit 4 is used for inputting data, for example, the master data or identification data on a motor vehicle to be repaired, in particular in the administration. Input unit 4 may be configured in such a way that the data entry takes place manually, i.e., by a keyboard, a mouse or a touchpad. Alternatively or additionally, the data input may take place automatically, for example, by a barcode reader, an RFID receiver or the like.

Mobile terminals 6, 8 are used for input and output of data in the repair shop operation.

Terminals 6, 8 each include a receiving unit 28 which is configured for receiving data from data management and/or data processing unit 2, a processing unit 32, which is configured for modifying and/or supplementing the data received from receiving unit 28 on the basis of the measuring results, and a transmitting unit 30 configured for transferring the modified and/or supplemented data from terminal 6, 8 to data management and/or data processing unit 2.

Terminals 6, 8 may be configured as terminals 6 having a diagnostic function (“diagnostic systems”) or terminals 8 without a diagnostic function.

Terminals 6 having a diagnostic function are able to carry out measurements and transfer the measuring results directly to data management and/or data processing unit 2, and large volumes of data may be transferred conveniently and transfer errors are reliably preventable. Terminals 6, 8 may be mobile measuring devices and/or other mobile devices such as tablet PCs or smartphones.

In the case of terminals 6 having a diagnostic function, the measuring results may be additionally displayed directly on terminal 6 for transfer to data management and/or data processing unit 2.

The collected and recorded data are processed and analyzed in data evaluation unit 2b. Results of the data evaluation may be displayed for the user directly via terminals 6, 8. Furthermore additional instructions for carrying out additional measurements and/or for repeating the measurement may be displayed for the user.

The data and the results of their evaluation may additionally be output via at least one output unit 10 set up outside of the repair shop, for example, a printer.

Data management unit 2a is connected to a “dealer management system” (DMS) 18 via an additional interface 12, whereby it is possible to transfer the data and the results of the data evaluation directly to DMS 18, to archive the data and results there and/or to link them to additional data and to generate an invoice automatically.

Dealer management systems 18 are used in the repair shop area, in particular for recording and compiling the orders, for managing the repairs and spare parts and for billing. From the data acquired when receiving the order, previously the usual paper work cards have been created and then processed further by hand by the mechanic. An information system 1 according to the present invention receives order data from DMS 18 via an interface, which may be standardized according to an industrial standard, and is able to electronically supplement and/or modify these data as described previously.

After the data supplemented or modified by information system 1 have been transferred to DMS 18, DMS 18 may be used for automatic billing. Information system 1 knows, for example, that the motor vehicle control unit has been read out. A lump sum may be calculated for that. Definitions of these costs, which are used for billing, are stored in DMS 18. Employees in the office and/or in the accounting office therefore need no longer be concerned about “typing up” the activities but instead receive a proposed invoice directly from the data in DMS 18. This increases efficiency in billing and reduces the risk of possible transfer errors.

The beginning and the end of repairs in the repair shop area are documented in information system 1. It is therefore also possible to check, on the basis of the collected data, on how long the throughput times are and/or what the work load of the mechanics is to reduce throughput times by optimum utilization of the mechanics.

Data management unit 2a may also have a third interface 14, making it possible to exchange data with external systems 16, for example, a vehicle manufacturer. A complex error analysis may be carried out on the external systems in this way and/or required spare parts may be ordered automatically.

In addition, a backup copy of the data may also be prepared on an external system 16.

Input devices and terminals 4, 6, 8 may each be provided with an authentication device 20, which makes it possible to identify the user of the particular input device or terminal 4, 6, 8 and to enable access to information system 1 only when the identified user has been authorized for use of information system 1. It is thus possible to reliably prevent misuse of information system 1.

The identification may take place, for example, by face recognition, voice recognition, on the basis of fingerprint features or with the aid of an RFID chip.

Input devices and terminals 4, 6, 8 may additionally be equipped with an identification device 22, which is configured for identifying an object, in particular a motor vehicle to be repaired. Identification devices 22 may each include a camera 24 and/or an RFID reader 26, which identifies the object on the basis of an external shape/color or on the basis of an RFID chip attached to the object.

1-13. (canceled)

14. An information system, for a motor vehicle repair shop, comprising:
at least one input unit to input data, including data on a motor vehicle to be repaired;
a data processing unit to store, manage and/or process the inputted data; and
at least one terminal to retrieve, reproduce and/or process data from the data processing unit and/or to input additional data using the at least one terminal and transfer the data to the data processing unit.

15. The information system of claim 14, wherein the at least one terminal is for carrying out measurements, on a motor vehicle to be repaired, and has a transmission unit, which provides for transferring the results of the measurements to the data processing unit.

16. The information system of claim 14, wherein the at least one terminal is for carrying out measurements, on the motor vehicle to be repaired, further comprising:
a receiving unit to receive data from the data processing unit,
a processing unit to modify and/or supplement the data received by the receiving unit based on the results of the measurements, and
a transmission unit to transfer the modified and/or supplemented data from the terminal to the data processing unit.

17. The information system of claim 14, wherein the at least one terminal includes a mobile terminal, a tablet PC, and or a smartphone.

18. The information system of claim 14, wherein the system is for enabling a wireless data transfer between the at least one terminal and the data processing unit.

19. The information system of claim 14, further comprising:
an electronic interface to transfer data to an external system.

20. The information system of claim 14, further comprising:
an authentication device to authenticate a user of the information system and/or to authorize the input and output of data.

21. The information system of claim 19, wherein the at least one terminal includes the authentication device.

22. The information system of claim 14, further comprising:
an identification device to identify an object, in particular a motor vehicle to be repaired, and to transfer identification data to the data processing unit.

23. The information system of claim 22, wherein the identification device includes a camera and/or an RFID reader.

24. A method for information processing, in particular for a motor vehicle repair shop, the method comprising:
inputting data, on a motor vehicle to be repaired, via at least one input unit;
transferring the data to a data processing unit for storing, managing and/or processing the inputted data; and
retrieving, reproducing and/or processing data using at least one terminal from the data processing unit and/or inputting additional data using the at least one terminal and transferring the data to the data processing unit.

25. The method of claim 24, the method further comprising:
carrying out measurements using the at least one terminal; and
transferring the measuring results to the data processing unit.

26. The method of claim 24, the method further comprising:
carrying out measurements using the at least one terminal and modifying and/or supplementing the data retrieved into the terminal based on the measuring results; and
transferring the modified and/or supplemented data from the terminal to the data processing unit.
